(19) United States
(12) Patent Application Publication
(10) Pub. No.: US 2023/0169515 A1
(43) Pub. Date: Jun. 1, 2023

(54) INTELLIGENT WARRANTY PRICING FRAMEWORK

(71) Applicant: Dell Products L.P., Round Rock, TX (US)

(72) Inventors: Bijan Kumar Mohanty, Austin, TX (US); Harish Mysore Jayaram, Cedar Park, TX (US); Hung Dinh, Austin, TX (US)

(73) Assignee: Dell Products L.P., Round Rock, TX (US)

(21) Appl. No.: 17/457,088

(22) Filed: Dec. 1, 2021

(51) Int. Cl. G06Q 30/00; G06N 3/04; G06N 3/08

(52) U.S. Cl. CPC G06Q 30/012; G06N 3/04; G06N 3/08

(57) ABSTRACT

In one aspect, an example methodology implementing the disclosed techniques includes, by a warranty system, receiving a customer-specific usage-related data for a product at a customer location and generating a feature vector for the product, wherein the feature vector represents one or more features from the customer-specific usage-related data. The method also includes, by the warranty system using a trained incident prediction module, predicting a number of future incidents for the product at the customer location based on the first feature vector. The method further includes, by the warranty system, determining a price for an extended warranty for the product based on the predicted number of future incidents for the product at the customer location.

### BACKGROUND

Companies, such as manufacturers, retailers, OEMs, etc., often provide warranties to consumers of products that they manufacture and/or sell. A warranty is a type of written promise or guarantee that a company or similar party makes regarding the condition of its products. The warranty may provide for repair, replacement, and/or service of a product within a specified period to the consumer should the product fail to meet promised quality or performance standards. A warranty that is provided with a product is typically intended to instill confidence in the consumer in the quality of the product as well as set expectations with respect to what can be expected if the product fails to perform as promised. Warranties may often affect a consumer's purchasing decision.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a computer implemented method to determine pricing for an extended warranty for a product includes, by a warranty system, receiving a customer-specific usage-related data for a product at a customer location and generating a feature vector for the product, wherein the feature vector represents one or more features from the customer-specific usage-related data. The method also includes, by the warranty system using a trained incident prediction module, predicting a number of future incidents for the product at the customer location based on the first feature vector. The method further includes, by the warranty system, determining a price for an extended warranty for the product based on the predicted number of future incidents for the product at the customer location.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to receive a customer-specific usage-related data for a product at a customer location and generate a feature vector for the product, wherein the feature vector represents one or more features from the customer-specific usage-related data. Execution of the instructions also causes the one or more processors to predict, using a trained incident prediction module, a number of future incidents for the product at the customer location based on the first feature vector. Execution of the instructions further causes the one or more processors to determine a price for an extended warranty for the product based on the predicted number of future incidents for the product at the customer location.

In some embodiments, the trained incident prediction module is trained using a training dataset generated from a corpus of historical product utilization and environment data.

According to another illustrative embodiment provided to illustrate the broader concepts described herein, a non-transitory, computer-readable storage medium has encoded thereon instructions that, when executed by one or more processors, causes a process to be carried out. The process includes receiving a customer-specific usage-related data for a product at a customer location and generating a feature vector for the product, wherein the feature vector represents one or more features from the customer-specific usage-related data. The process also includes predicting, using a trained incident prediction module, a number of future incidents for the product at the customer location based on the first feature vector, wherein the trained incident prediction module is trained using a training dataset generated from a corpus of historical product utilization and environment data. The process further includes determining a price for an extended warranty for the product based on the predicted number of future incidents for the product at the customer location.

In some embodiments, the trained incident prediction module includes a dense neural network (DNN). In one aspect, the DNN of the trained incident prediction module functions as a regression-based model.

In some embodiments, the one or more features includes a feature regarding utilization of the product by a customer.

In some embodiments, the one or more features includes a feature regarding a location at which the product is used.

In some embodiments, receiving the customer-specific usage-related data includes receiving at least some of the customer-specific usage-related data from the product.

In some embodiments, receiving the customer-specific usage-related data includes receiving at least some of the customer-specific usage-related data from a device at the customer location.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative architecture of a warranty system, in accordance with an embodiment of the present disclosure.

FIG. 2 is a diagram showing an illustrative data structure that represents a training dataset for training a learning model to predict a number of future incidents for a product, in accordance with an embodiment of the present disclosure.

FIG. 3 is a diagram illustrating an example architecture of a dense neural network (DNN) model of an incident prediction module, in accordance with an embodiment of the present disclosure.

FIG. 4 is a diagram showing an example incident prediction topology that can be used to predict a number of future incidents for a product, in accordance with an embodiment of the present disclosure.

FIG. 5 is a flow diagram of an example process for determining a price for an extended warranty for a product being used by a customer, in accordance with an embodiment of the present disclosure.

FIG. 6 is a block diagram illustrating selective components of an example computing device in which various aspects of the disclosure may be implemented, in accordance with an embodiment of the present disclosure.

### DETAILED DESCRIPTION

Warranties usually have exceptions that limit the conditions in which company, such as a manufacturer, will be obligated to rectify a problem. For example, many warranties for products such as common household items only cover a product for up to one year from the date of purchase and usually only if the product in question contains problems resulting from defective parts or workmanship. As a result of these limited manufacturer warranties, many vendors offer extended warranties. These extended warranties are essentially insurance policies for products that consumers pay for upfront. Extended warranty coverage may last for a specified duration (e.g., a number of years) above and beyond the manufacturer's warranty and may be more lenient in terms of the limited terms and conditions. Such an extended warranty for a product may be offered to customers during the purchase of the product or subsequent to the purchase of the product. However, the pricing for such extended warranties are often based on static and heuristic-based rules. For example, many extended warranties use a one size fits all approach which uses a uniform price for an extended warranty for a product based only on the age of the product.

It is appreciated herein that such trivial pricing approaches fail to consider other factors which can significantly impact the operation of the product and contribute to efficiency, defects and eventual lifespan of the product and its parts. Examples of such factors may include product usage behavior of the customer (e.g., gently, roughly, frequently, less frequently, constantly, heavy utilization, light utilization, indoor, outdoor, covered, uncovered, etc.), and customer location environmental conditions (e.g., ambient temperature, humidity, air pressure, among others), to provide a couple examples. Typically, product utilization or usage varies from one customer to another. For example, while one customer can use a product gently (e.g., carefully), another customer can use the same product roughly or in a manner that is not so gentle. In the case of an information technology (IT) product, such as a server device or a storage device, product utilization can also include numbers of Install, Move, Add, Change (IMAC), deployments, system alerts, error logs, etc. Similarly, the environmental conditions can also vary from one customer location to another. In short, the manner and the conditions in which a customer uses a product can affect the number of issues and/or defects experienced by the product as well as the lifespan of the product. The number of issues and/or defects experienced by the product can influence the costs that can be incurred by a vendor (e.g., a company) in supporting and maintaining the product under an extended warranty.

A potential application of machine learning (ML) is for predicting the number of future incidents/defects (e.g., sometimes referred to herein more simply as “future incidents”) that may be experienced by a product. The predicted number of future incidents for a product is a good indicator of an estimate of the product maintenance costs that can be expected to be incurred by a company (e.g., a company manufacturing and/or selling the product). This, in turn, may allow the company to determine an accurate and fair price for an extended warranty for the product. A fair price for an extended warranty may be important to a customer's decision to purchase as well as ultimate satisfaction with the product. Higher product satisfaction can result in improved product and brand value for the company.

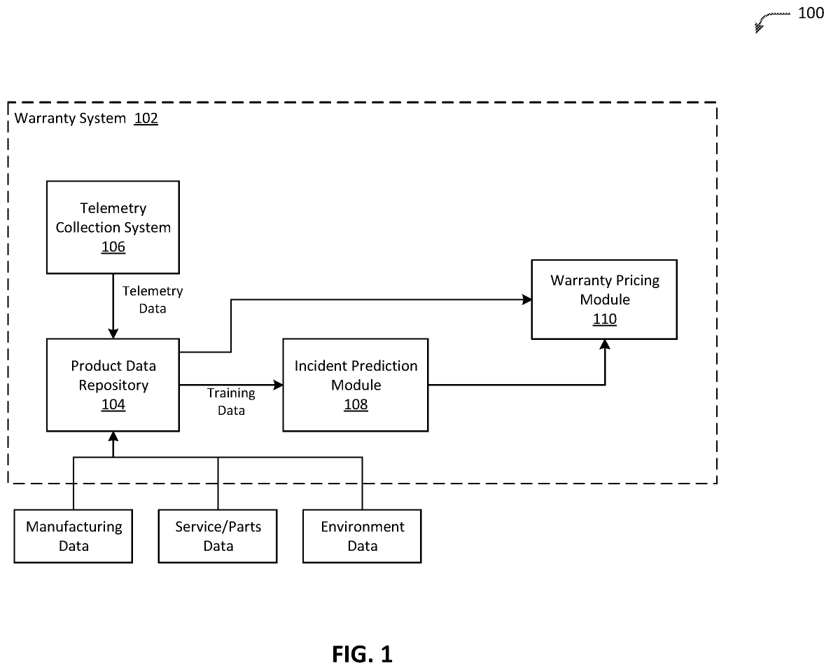

To this end, certain embodiments of the concepts, techniques, and structures disclosed herein are directed to predicting a number of future incidents that can be expected for a product based on customer-specific usage-related data for the product. Customer-specific usage-related data for a product may include customer-specific product utilization data (e.g., product utilization metrics) and customer-specific location environmental data (e.g., environmental condition metrics). In some embodiments, a learning model (e.g., a regression-based deep learning model) may be trained using machine learning techniques (including neural networks) to predict a number of future incidents that can be expected for a product that is being used by a customer. For example, to train the model, historical product utilization and environment data can be collected. As alluded to above, historical product utilization and environmental data is a good indicator for predicting the number of future incidents for products (e.g., predicting the number of future incidents that will be encountered by the product) owned and/or used by a customer. The product utilization and environment data may be collected from variety of sources, as will be further described below at least in conjunction with FIG. 1.

Once the historical product utilization and environment metrics data is collected, the variables or parameters (also called features) that are correlated to or influence (or contribute to) the number of incidents encountered by a product can be determined (e.g., identified) from the corpus of historical product utilization and environment data. These relevant features can then be used to generate a dataset (e.g., a training dataset) that can be used to train the model. A feature (also known as an independent variable in machine learning) is an attribute that is useful or meaningful to the problem that is being modeled (i.e., predicting the number of incidents for a product). For example, in the case of electronic devices, the relevant features may include information regarding the customer who is utilizing the product, customer location, the product itself (e.g., product configuration), age (i.e., age of the product), product utilization by the customer (e.g., manner in which the product is being utilized, the number of IMAC, number of deployments, etc.), ambient temperature, ambient humidity, ambient air pressure, number of product system alerts, and the number of product error logs or reports. As another example, in the case of home appliances (e.g., a refrigerator), the relevant features may include information regarding the customer who is utilizing the refrigerator, customer location, the product itself (e.g., refrigerator model), product utilization by the customer (e.g., manner in which the refrigerator is being utilized such as the number of times the doors are opened/closed, the refrigerator/freezer temperature setting(s), number and frequency of change to the temperature setting(s), the frequency in which the motor (e.g., compressor) runs, etc.), ambient temperature, and ambient humidity. The above are only two examples and other types of products are envisioned. In any case, being able to accurately estimate a number of future incidents for a product used by a customer allows a company to determine an accurate and fair price for an extended warranty for the product to offer to the customer.

Although certain embodiments and/or examples are described herein in the context of electronic devices, it will be appreciated in light of this disclosure that such embodiments and/or examples are not restricted as such, but are applicable to any type of product that is manufactured and sold, in the general sense. Numerous variations and configurations will be apparent in light of this disclosure.

Referring now to the figures, FIG. 1 is a diagram of an illustrative architecture 100 of a warranty system 102, in accordance with an embodiment of the present disclosure. A company, for instance, may implement and utilize warranty system 102 to predict (e.g., estimate) a number of future incidents for a product used by a customer (e.g., sold to a customer) and use the prediction as one factor in determining a price for an extended warranty for the product to offer to the customer. As shown, warranty system 102 includes a product data repository 104, a telemetry collection system 106, an incident prediction module 108, and a warranty pricing module 110. Warranty system 102 can include various other hardware and software components which, for the sake of clarity, are not shown in FIG. 1. It is also appreciated that warranty system 102 may not include certain of the components depicted in FIG. 1. For example, in certain embodiments, warranty system 102 may not include warranty pricing model 110. In such embodiments, the output from incident prediction module 108 (e.g., the number of future incidents predicted for a product) may be provided to the company's warranty sales team for use in determining a price for an extended warranty for the product. As another example, in some embodiments, warranty system 102 may not include telemetry collection system 106. Rather, in such embodiments, the functionality provided by telemetry collection system 106 may be provided by a system and/or module that is external to (e.g., not included in) warranty system 102. More generally, some or all the functionality provided by the excluded components may be provided by one or more of the included components of warranty system 102 or provided by one or more systems that are external to warranty system 102. Thus, it should be appreciated that numerous configurations of warranty system 102 can be implemented and the present disclosure is not intended to be limited to any particular one.

The various components of architecture 100, including the components of warranty system 102, may be communicably coupled to one another via one or more networks (not shown). The network may correspond to one or more wired or wireless computer networks including, but not limited to, local area networks (LANs), wide area networks (WANs), personal area networks (PANs), metropolitan area networks (MANs), storage area networks (SANs), virtual private networks (VPNs), wireless local-area networks (WLAN), primary public networks, primary private networks, Wi-Fi (i.e., 802.11) networks, other types of networks, or some combination of the above.

Telemetry collection system 106 is operable to collect or otherwise obtain telemetry data form the company's products. For example, the company's products may include smart clients (e.g., Internet of Things (IoT) devices) that periodically or continuously capture product utilization and environment metrics and send or otherwise provide the captured telemetry data to telemetry collection system 106. Non-limiting examples of types of product utilization and environment telemetry data that can be provided include error logs (e.g., number and/or records of the errors encountered by the product during use), system alerts (e.g., number and/or records of the special circumstances encountered during product operation), On/Off statistics (e.g., number of times the product is turned On/Off), configuration changes (e.g., number of changes to the configuration of the product), network changes (e.g., number of changes to the network and/or networking capabilities of the product), IMAC (e.g., number of installs, moves, adds, and/or changes experienced by the product), resource utilization (e.g., resources utilized by the product), ambient temperature, ambient humidity, ambient air pressure, and vibration (e.g., product and/or parts/components vibration statistics), among others. The company's products at the customer locations may provide the telemetry data while utilized by the customer (e.g., during the product's utilization by the customer). It will be appreciated that the types of metrics data provided above are merely illustrative and that the types of metrics data may vary depending on the product and/or type of product. Also, some products may provide other types of metrics data in addition to some or all of those illustrated above.

Product data repository 104 stores or otherwise records the historical product utilization and environment data. The historical product utilization and environment data may include information regarding the products sold or otherwise provided by the company (e.g., customers who are using the products, parts included in the products, configuration of the products, etc.), the manner in which these products are used and/or have been used by the customers (e.g., customer-specific product utilization data), the environmental conditions in which these products are used and/or have been used by the customers (e.g., customer-specific location environmental data), and the number of incidents (e.g., issues and/or defects) experienced by these products, for example, during use by the customers. For example, as can be seen in FIG. 1, some historical product utilization and environment data (e.g., the telemetry data collected from the products at the customer locations) may be collected or otherwise obtained from telemetry collection system 106. Other information regarding the company's products at the customer locations (e.g., information regarding the company using the product, configuration of the product (e.g., parts or components included in the product), and the number and/or types of incidents encountered by the product, etc.) may be collected or otherwise obtained from the company's CRM services/parts systems. Other types of information, such as customer location specific general environment/weather data may be collected or obtained from various weather systems. This data may be useful for products, such as heating, ventilation, and air conditioning (HVAC) systems and the like, that are operated outside a controlled environment. Thus, in such embodiments, product data repository 104 can be understood as a storage point for data that is collected from the company's various enterprise systems (e.g., telemetry collection system 106, CRM services system, parts system) and, in some case, the weather systems, and which is used to generate a training dataset that can be used to train a model (e.g., incident prediction module 108) to predict a number of a number of future incidents for a product that is being used by a customer.

In some embodiments, the historical product utilization and environment data may be stored in a tabular format. In the table, the structured columns represent the features (also called variables) and each row represents an observation or instance (e.g., a product at a customer location). Thus, each column in the table shows a different feature of the instance. In some embodiments, product data repository 104 can perform preliminary operations with the collected historical product utilization and environment data (e.g., customer-specific product utilization and environment information regarding the past products sold by the company) to generate the training dataset. For example, the preliminary operations may include null data handling (e.g., the handling of missing values in the table). According to one embodiment, null or missing values in a column (a feature) may be replaced by a mode or median value of the values in that column. According to alternative embodiments, observations in the table with null or missing values in a column may be removed from the table.

The preliminary operations may also include feature selection and/or data engineering to determine (e.g., identify) the relevant features from the historical product utilization and environment data. The relevant features are the features that are more correlated with the thing being predicted by the trained model (e.g., number of incidents encountered by the product). A variety of feature engineering techniques, such as exploratory data analysis (EDA) and/or bivariate data analysis with multivariate-variate plots and/or correlation heatmaps and diagrams, among others, may be used to determine the relevant features. Such feature engineering may be performed to reduce the dimension and complexity of the trained model, hence improving its accuracy and performance.

The preliminary operations may also include data preprocessing to place the data (information) in the table into a format that is suitable for training a model. For example, since machine learning deals with numerical values, textual categorical values (i.e., free text) in the columns (e.g., customer, product, utilization, customer location, etc.) can be converted (i.e., encoded) into numerical values. According to one embodiment, the textual categorical values may be encoded using label encoding. According to alternative embodiments, the textual categorical values may be encoded using one-hot encoding.

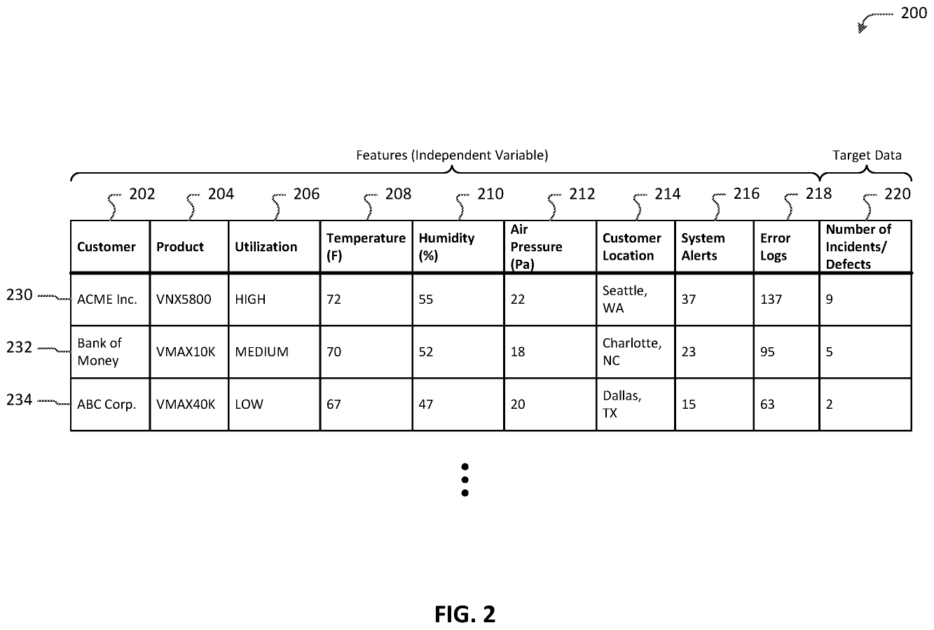

FIG. 2 is a diagram showing an illustrative data structure 200 that represents a training dataset for training a learning model to predict a number of future incidents for a product, in accordance with an embodiment of the present disclosure. More specifically, data structure 200 may be in a tabular format in which the structured columns represent the different relevant features (variables) regarding the past products sold or otherwise provided to customers by the company and a row represents individual products sold or otherwise provided to the customers. The relevant features illustrated in data structure 200 are merely examples of features that may be extracted from the historical product utilization and environment data and used to generate a training dataset and should not be construed to limit the embodiments described herein.

As shown in FIG. 2, the relevant features may include a customer 202, a product 204, a utilization 206, a temperature 208, a humidity 210, an air pressure 212, a customer location 214, a system alerts 216, an error logs 218, and a number of incidents/defects 220. Customer 202 indicates a customer who purchased or otherwise obtained the product (i.e., customer who is using the product sold or otherwise provided by the company). Product 204 indicates a product number that identifies the product. Utilization 206 indicates the extent to which the product is utilized (e.g., “HIGH” to indicate high utilization; “MEDIUM” to indicate medium or normal utilization; “LOW” to indicate low utilization). Temperature 208 indicates an average ambient temperature measured by the product (e.g., a smart client of the product). Humidity 210 indicates an average ambient humidity measured by the product (e.g., a smart client of the product). Air pressure 212 indicates an average ambient air pressure measured by the product (e.g., a smart client of the product). Customer location 214 indicates a location at which the customer is using (utilizing) the product. For example, the different customer locations may impact the efficiency and/or contribute to defects and eventual life span of the product and its parts/components. System alters 216 indicates the number of special circumstances encountered by the product during operation. Error logs 218 indicates the number of errors encountered by the product during use. Number of incidents/defects 220 indicates the number of incidents encountered by the product (e.g., the number of incidents reported for the product).

In data structure 200, each row may represent a training sample (i.e., an instance of a training sample) in the training dataset, and each column may show a different relevant feature of the training sample. Each training sample may correspond to a past product that was sold or otherwise provided to a customer by the company. As can be seen in FIG. 2, three training samples 230, 232, 234 are illustrated in data structure 200. In some embodiments, the individual training samples 230, 232, 234 may be used to generate a feature vector, which is a multi-dimensional vector of elements or components that represent the features in a training sample. In such embodiments, the generated feature vectors may be used for training a model to predict a number of future incidents for a product. The features customer 202, product 204, utilization 206, temperature 208, humidity 210, air pressure 212, customer location 214, system alerts 216, and error logs 218 may be included in a training sample as the independent variables, and the feature number of incidents/defects 220 included as the dependent (or target) variable in the training sample. Note that the number of training samples depicted in data structure 200 is for illustration, and those skilled in the at will appreciate that the training dataset may, and likely will, include large and sometimes very large numbers of training samples.

Referring again to FIG. 1, incident prediction module 108 can predict a number of future incidents for a product at a customer location. In other words, incident prediction module 108 can estimate a number of future incidents that can be expected for a product at a customer location. To this end, in some embodiments, incident prediction module 108 includes a learning model (e.g., a dense neural network (DNN)) that is trained using machine learning techniques with a training dataset generated using historical product data. The DNN may be a regression-based deep learning model (e.g., a sophisticated regressor). In such embodiments, the training dataset may be provided by product data repository 104. In some embodiments, a randomly selected portion of the training dataset can be used for training the DNN, and the remaining portion of the training dataset can be used as a testing dataset. In one embodiment, 70% of the training dataset can be used to train the model, and the remaining 30% can be used to form the testing dataset. The model can then be trained using the portion of the training dataset (i.e., 70% of the training dataset) designated for training the model. Once trained, the testing dataset can be applied to the trained model to evaluate the performance of the trained model.

In brief, the DNN includes an input layer for all input variables such as customer, product, ae (e.g., age of the product), utilization, temperature, customer location, system alerts, error logs, etc., multiple hidden layers for feature extraction, and an output layer. Each layer may be comprised of a number of nodes or units embodying an artificial neuron (or more simply a “neuron”). As a DNN, each neuron in a layer receives an input from all the neurons in the preceding layer. In other words, every neuron in each layer is connected to every neuron in the preceding layer and the succeeding layer. As a regression model, the output layer is comprised of a single neuron, which outputs a numerical value representing the number of incidents.

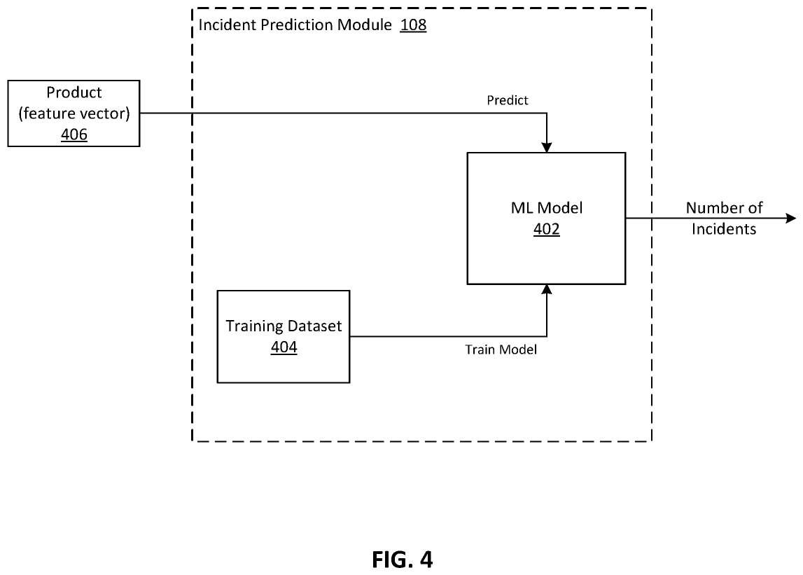

In more detail, and as shown in FIG. 4, a DNN 300 includes an input layer 302, multiple hidden layers 304 (e.g., two hidden layers), and an output layer 306. Input layer 302 may be comprised of a number of neurons to match (i.e., equal to) the number of input variables (independent variables). Taking as an example the independent variables illustrated in data structure 200 (FIG. 2), input layer 302 may include nine (9) neurons to match the nine (9) independent variables (e.g., customer 202, product 204, utilization 206, temperature 208, humidity 210, air pressure 212, customer location 214, system alerts 216, and error logs 218), where each neuron in input layer 302 receives a respective independent variable. Each succeeding layer (e.g., a first layer and a second layer) in hidden layers 304 will further comprise an arbitrary number of neurons, which may depend on the number of neurons included in input layer 302. For example, according to one embodiment, the number of neurons in the first hidden layer may be determined using the relation 2ⁿ≥number of neurons in input layer, where n is the smallest integer value satisfying the relation. In other words, the number of neurons in the first layer of hidden layers 304 is the smallest power of 2 value equal to or greater than the number of neurons in input layer 302. For example, in the case where there are 19 input variables, input layer 302 will include 19 neurons. In this example case, the first layer can include 32 neurons (i.e., 2⁵=32). Each succeeding layer in hidden layers 304 may be determined by decrementing the exponent n by a value of one. For example, the second layer can include 16 neurons (i.e., 2⁴=16). In the case where there is another succeeding layer (e.g., a third layer) in hidden layers 304, the third layer can include eight (8) neurons (i.e., 2³=8). As a regression model, output layer 306 includes a single neuron.

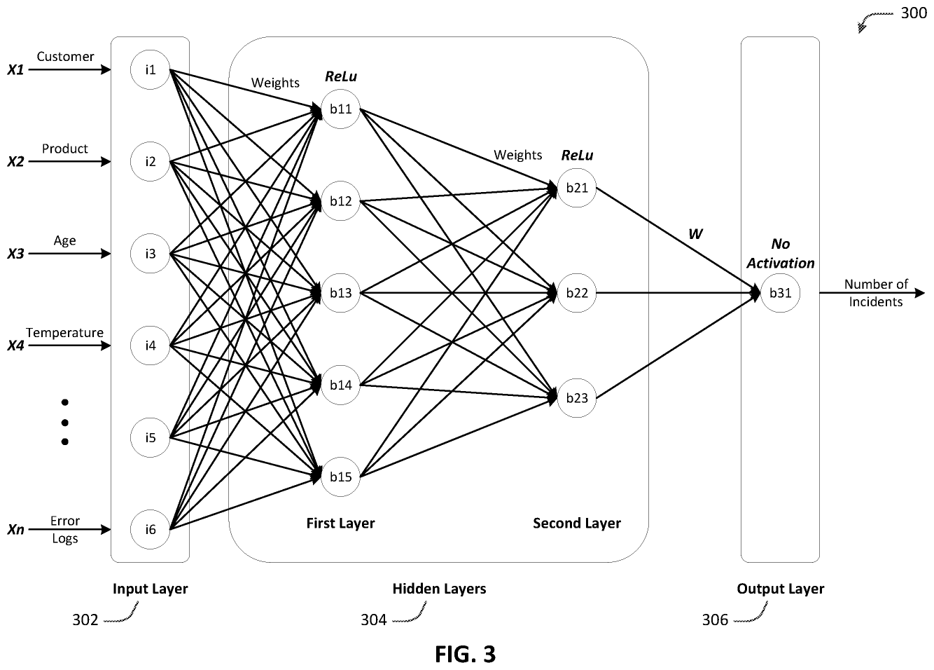

Although FIG. 3 shows hidden layers 304 comprised of only two layers, it will be understood that hidden layers 304 may be comprised of a different number of hidden layers. Also, the number of neurons shown in the first layer and in the second layer of hidden layers 304 is for illustration only, and it will be understood that actual numbers of neurons in the first layer and in the second layer of hidden layers 304 may be based on the number of neurons in input layer 302.

Each neuron in hidden layers 304 and the neuron in output layer 306 may be associated with an activation function. For example, according to one embodiment, the activation function for the neurons in hidden layers 304 may be a rectified linear unit (ReLU) activation function. As DNN 300 is to function as a regression model, the neuron in output layer 306 will not contain an activation function.

Since this is a dense neural network, as can be seen in FIG. 3, each neuron in the different layers may be coupled to one another. Each coupling (i.e., each interconnection) between two neurons may be associated with a weight, which may be learned during a learning or training phase. Each neuron may also be associated with a bias factor, which may also be learned during a training process.

During a first pass (epoch) in the training phase, the weight and bias values may be set randomly by the neural network. For example, according to one embodiment, the weight and bias values may all be set to 1 (or 0). Each neuron may then perform a linear calculation by combining the multiplication of each input variables (x1, x2, . . . ) with their weight factors and then adding the bias of the neuron. The equation for this calculation may be as follows:

ws1=x1·w1+x2·w2+ ⋅ ⋅ ⋅ +b1,

where ws1 is the weighted sum of the neuron1, x1, x2, etc. are the input values to the model, w1, w2, etc. are the weight values applied to the connections to the neuron1, and b1 is the bias value of neuron1. This weighted sum is input to an activation function (e.g., ReLU) to compute the value of the activation function. Similarly, the weighted sum and activation function values of all the other neurons in a layer are calculated. These values are then fed to the neurons of the succeeding (next) layer. The same process is repeated in the succeeding layer neurons until the values are fed to the neuron of output layer 306. Here, the weighted sum may also be calculated and compared to the actual target value. Based on the difference, a loss value is calculated. The loss value indicates the extent to which the model is trained (i.e., how well the model is trained). This pass through the neural network is a forward propagation, which calculates the error and drives a backpropagation through the network to minimize the loss or error at each neuron of the network. Considering the error/loss is generated by all the neurons in the network, backpropagation goes through each layer from back to forward and attempts to minimize the loss using, for example, a gradient descent-based optimization mechanism or some other optimization method. Since the neural network is used as a regressor, mean squared error may be used as the loss function and adaptive movement estimation (Adam) used as the optimization algorithm.

The result of this backpropagation is used to adjust (update) the weight and bias values at each connection and neuron level to reduce the error/loss. An epoch (one pass of the entire training dataset) is completed once all the observations of the training data are passed through the neural network. Another forward propagation (e.g., epoch 2) may then be initiated with the adjusted weight and bias values and the same process of forward and backpropagation may be repeated in the subsequent epochs. Note that a higher loss value means the model is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train the model. In any case, once the loss is reduced to a very small number (ideally close to zero (0)), the neural network is sufficiently trained for prediction.

For example, DNN 300 can be built by first creating a shell model and then adding desired number of individual layers to the shell model. For each layer, the number of neurons to include in the layer can be specified along with the type of activation function to use and any kernel parameter settings. Once DNN 300 is built, a loss function (e.g., mean squared error), an optimizer algorithm (e.g., Adam), and validation metrics (e.g., mean squared error (mse); mean absolute error (mae)) can be specified for training, validating, and testing DNN 300.

DNN 300 can then be trained by passing the portion of the training dataset (e.g., 70% of the training dataset) designated for training and specifying a number of epochs. An epoch (one pass of the entire training dataset) is completed once all the observations of the training data are passed through DNN 300. DNN 300 can be validated once DNN 300 completes the specified number of epochs. For example, DNN 300 can process the training dataset and the loss/error value can be calculated and used to assess the performance of DNN 300. The loss value indicates how well DNN 300 is trained. Note that a higher loss value means DNN 300 is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train DNN 300. In any case, once the loss is reduced to a very small number (ideally close to 0), DNN 300 is sufficiently trained for prediction. Prediction of the model (e.g., DNN 300) can be achieved by passing the independent variables of test data (i.e., for comparing train vs. test) or the real values that need to be predicted to predict the estimated number of future incidents (i.e., target variable).

Once sufficiently trained, as illustrated in FIG. 4 in which like elements of FIG. 1 are shown using like reference designators, incident prediction module 108 can be used to predict a number of future incidents for a product used by a customer. As shown in FIG. 4, incident prediction module 108 includes a machine learning (ML) model 402. As described previously, according to one embodiment, ML model 402 can be a DNN (e.g., DNN 300 of FIG. 3). ML model 402 can be trained and tested using machine learning techniques with a training dataset 404. Training data set 404 can be provided by product data repository 104. As described previously, the training dataset for ML model 402 may be generated from the corpus of historical product utilization and environment data. The trained ML model 402 can then be used to predict a number of future incidents for a product used by a customer (e.g. a product sold or otherwise provided to the customer by the company). For example, a feature vector that represents the customer-specific usage-related data for a product 406, such as some or all the customer-specific product utilization metrics and the customer-specific location environmental condition metrics (e.g., customer, product, utilization, temperature, humidity, customer location, etc.), may be input, passed, or otherwise provided to the trained ML model 402. In some embodiments, the input feature vector (e.g., the feature vector representing product 406) may include the same features used in training the trained ML model 402.

Referring again to FIG. 1, warranty pricing module 110 is operable to determine (e.g., compute) a price for an extended warranty for a product at a customer location. In some embodiments, warranty pricing module 110 can determine a price for an extended warranty for a product by applying one or more pricing rules which consider the predicted number of future incidents for the product (e.g., output from incident prediction module 108) as one factor, determinant, or limitation in determining a price. In some such embodiments, the pricing rules may be defined by the company (e.g., the company's warranty sales team).

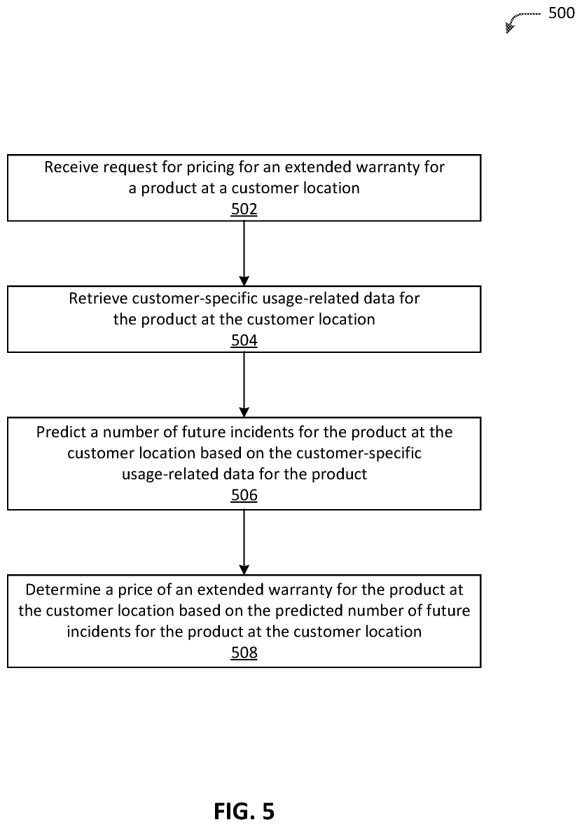

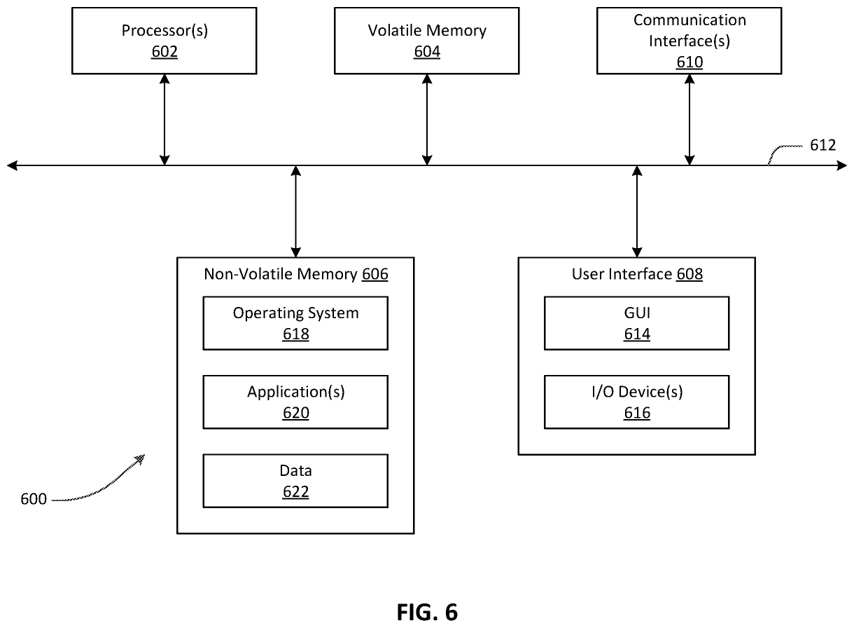

FIG. 5 is a flow diagram of an example process 500 for determining a price for an extended warranty for a product being used by a customer, in accordance with an embodiment of the present disclosure. Process 500 may be implemented or performed by any suitable hardware, or combination of hardware and software, including without limitation the system shown and described with respect to FIG. 1, the computing device shown and described with respect to FIG. 6, or a combination thereof. For example, in some embodiments, the operations, functions, or actions illustrated in process 500 may be performed, for example, in whole or in part by telemetry collection system 106, incident prediction module 108, and warranty pricing module 110, or any combination of these including other components of warranty system 102 described with respect to FIG. 1.

With reference to process 500 of FIG. 5, and in an illustrative use case, at 502, a request for pricing for an extended warranty for a product at a customer location is received. For example, the request for pricing for an extended warranty for the product can be received by a component of warranty system 102 (e.g., warranty pricing module 110). This request may be to determine (e.g., compute) a price for an extended warranty for the product to offer to the customer.

At 504, the customer-specific usage-related data for the product is retrieved. The customer-specific usage-related data for that product (i.e., the product at the customer location), which can include customer location specific general environment/weather data, can be retrieved from product data repository 104.

At 506, a number of future incidents for the product at the customer location is predicted based on the customer-specific usage-related data for that product. The prediction of the number of future incidents for the product can be made using incident prediction module 108. For example, a feature vector representing some or all the customer-specific usage-related data for that product can be generated and input to incident prediction module 108 which outputs a predicted number of future incidents for that product.

At 508, a price for an extended warranty for the product at the customer location id determined based on the predicted number of future incidents for the product at the customer location. The price for the extended warranty can be determined using warranty pricing module 110. For example, the price for the extended warranty can be determined by applying one or more pricing rules which consider the predicted number of future incidents for the product as one factor, determinant, or limitation in determining a price. As one example, the determined price for the extended warranty for the product at the customer location may then be provided to, for example, the company's warranty team for consideration in offering to the customer.

FIG. 6 is a block diagram illustrating selective components of an example computing device 600 in which various aspects of the disclosure may be implemented, in accordance with an embodiment of the present disclosure. As shown, computing device 600 includes one or more processors 602, a volatile memory 604 (e.g., random access memory (RAM)), a non-volatile memory 606, a user interface (UI) 608, one or more communications interfaces 610, and a communications bus 612.

Non-volatile memory 606 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 608 may include a graphical user interface (GUI) 614 (e.g., a touchscreen, a display, etc.) and one or more input/output (I/O) devices 616 (e.g., a mouse, a keyboard, a microphone, one or more speakers, one or more cameras, one or more biometric scanners, one or more environmental sensors, and one or more accelerometers, etc.).

Non-volatile memory 606 stores an operating system 618, one or more applications 620, and data 622 such that, for example, computer instructions of operating system 618 and/or applications 620 are executed by processor(s) 602 out of volatile memory 604. In one example, computer instructions of operating system 618 and/or applications 620 are executed by processor(s) 602 out of volatile memory 604 to perform all or part of the processes described herein (e.g., processes illustrated and described in reference to FIGS. 1 through 5). In some embodiments, volatile memory 604 may include one or more types of RAM and/or a cache memory that may offer a faster response time than a main memory. Data may be entered using an input device of GUI 614 or received from I/O device(s) 616. Various elements of computing device 600 may communicate via communications bus 612.

The illustrated computing device 600 is shown merely as an illustrative client device or server and may be implemented by any computing or processing environment with any type of machine or set of machines that may have suitable hardware and/or software capable of operating as described herein.

Processor(s) 602 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 602 may be analog, digital or mixed signal. In some embodiments, processor 602 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 610 may include one or more interfaces to enable computing device 600 to access a computer network such as a Local Area Network (LAN), a Wide Area Network (WAN), a Personal Area Network (PAN), or the Internet through a variety of wired and/or wireless connections, including cellular connections.

In described embodiments, computing device 600 may execute an application on behalf of a user of a client device. For example, computing device 600 may execute one or more virtual machines managed by a hypervisor. Each virtual machine may provide an execution session within which applications execute on behalf of a user or a client device, such as a hosted desktop session. Computing device 600 may also execute a terminal services session to provide a hosted desktop environment. Computing device 600 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A computer implemented method to determine pricing for an extended warranty for a product, the method comprising:
receiving, by a warranty system, a customer-specific usage-related data for a product at a customer location;
generating, by the warranty system, a feature vector for the product, the feature vector represents one or more features from the customer-specific usage-related data;
predicting, by the warranty system using a trained incident prediction module, a number of future incidents for the product at the customer location based on the first feature vector; and
determining, by the warranty system, a price for an extended warranty for the product based on the predicted number of future incidents for the product at the customer location.

2. The method of claim 1, wherein the trained incident prediction module is trained using a training dataset generated from a corpus of historical product utilization and environment data.

3. The method of claim 1, wherein the trained incident prediction module includes a dense neural network (DNN).

4. The method of claim 3, wherein the DNN of the trained incident prediction module functions as a regression-based model.

5. The method of claim 1, wherein the one or more features includes a feature regarding utilization of the product by a customer.

6. The method of claim 1, wherein the one or more features includes a feature regarding a location at which the product is used.

7. The method of claim 1, wherein receiving the customer-specific usage-related data includes receiving at least some of the customer-specific usage-related data from the product.

8. The method of claim 1, wherein receiving the customer-specific usage-related data includes receiving at least some of the customer-specific usage-related data from a device at the customer location.

9. A system comprising:
one or more non-transitory machine-readable mediums configured to store instructions; and
one or more processors configured to execute the instructions stored on the one or more non-transitory machine-readable mediums, wherein execution of the instructions causes the one or more processors to:
receive a customer-specific usage-related data for a product at a customer location;
generate a feature vector for the product, the feature vector represents one or more features from the customer-specific usage-related data;
predict, using a trained incident prediction module, a number of future incidents for the product at the customer location based on the first feature vector; and
determine a price for an extended warranty for the product based on the predicted number of future incidents for the product at the customer location.

10. The system of claim 9, wherein the trained incident prediction module is trained using a training dataset generated from a corpus of historical product utilization and environment data.

11. The system of claim 9, wherein the trained incident prediction module includes a dense neural network (DNN).

12. The system of claim 11, wherein the DNN of the trained incident prediction module functions as a regression-based model.

13. The system of claim 9, wherein the one or more features includes a feature regarding utilization of the product by a customer.

14. The system of claim 9, wherein the one or more features includes a feature regarding a location at which the product is used.

15. The system of claim 9, wherein to receive the customer-specific usage-related data includes to receive at least some of the customer-specific usage-related data from the product.

16. The system of claim 9, wherein to receive the customer-specific usage-related data includes to receive at least some of the customer-specific usage-related data from a device at the customer location.

17. A non-transitory, computer-readable storage medium has encoded thereon instructions that, when executed by one or more processors, causes a process to be carried out, the process comprising:
receiving a customer-specific usage-related data for a product at a customer location;
generating a feature vector for the product, the feature vector represents one or more features from the customer-specific usage-related data;
predicting, using a trained incident prediction module, a number of future incidents for the product at the customer location based on the first feature vector, wherein the trained incident prediction module is trained using a training dataset generated from a corpus of historical product utilization and environment data; and
determining a price for an extended warranty for the product based on the predicted number of future incidents for the product at the customer location.

18. The storage medium of claim 17, wherein the trained incident prediction module includes a regression-based model.

19. The storage medium of claim 17, wherein the one or more features includes a feature regarding utilization of the product by a customer or a location at which the product is used.

20. The storage medium of claim 17, wherein receiving the customer-specific usage-related data includes receiving at least some of the customer-specific usage-related data from the product or receiving at least some of the customer-specific usage-related data from a device at the customer location.
